(19) United States
(12) Patent Application Publication
(10) Pub. No.: US 2025/0134767 A1
(43) Pub. Date: May 1, 2025

(54) BATHTUB MASSAGE NOZZLE

(71) Applicant: Guangzhou Rising Dragon Recreation Industrial Co., Ltd., Guangzhou (CN)

(72) Inventors: Bo PENG, Guangzhou (CN); Weixin TANG, Guangzhou (CN)

(73) Assignee: Guangzhou Rising Dragon Recreation Industrial Co., Ltd., Guangzhou (CN)

(21) Appl. No.: 18/664,313

(22) Filed: May 15, 2024

(30) Foreign Application Priority Data
Nov. 1, 2023 (CN) 202322944822.2

(51) Int. Cl. A61H 33/00

(52) U.S. Cl. CPC A61H 33/6021

(57) ABSTRACT

A bathtub massage nozzle includes a nozzle body, a nozzle core seat and a nozzle surface cover. The nozzle surface cover includes a nozzle surface cover body and a decorative ring, and the surface of the decorative ring away from the nozzle surface cover body is provided with decorative patterns. The decorative ring makes the nozzle surface cover more exquisite, and the decorative pattern gives the overall appearance more sense of layering and three-dimensionality, which makes the nozzle not only a functional product, but also more aesthetic, bringing users a pleasant visual experience and satisfying consumers' demands for aesthetics and personalization. The decorative ring also improves the nozzle wear resistance and aging resistance, and prolongs the service life of the product. Therefore, the bathtub massage nozzle meets the users' demand for better aesthetic feel and comfort, and is a massage nozzle integrating aesthetics, practicality and durability.

### TECHNICAL FIELD

The present invention relates to the technical field of massage nozzles, in particular to a bathtub massage nozzle.

### BACKGROUND

With the continuous progress of science and technology, people's pursuit of quality of life has been constantly growing. In this context, massage bathtubs, as a device that can provide a comfortable and relaxing experience, have gradually become a popular choice for modern families. However, although existing bathtub massage systems have been greatly improved in function, there is still much room for improvement in appearance design. The traditional bathtub massage nozzle usually presents a monotonous appearance, and what users see in the process of enjoying massage is often just an ordinary plastic structure, which lacks aesthetics. Therefore, in order to meet the expectations of modern consumers for high-quality life and the pursuit of aesthetics and comfort, there is a need to provide an improved bathtub massage nozzle with a more exquisite appearance, so that it can stand out in the fiercely competitive market and bring users a higher-quality massage experience.

### SUMMARY

The present invention is directed to a bathtub massage nozzle, which solves the problem that the traditional bathtub massage nozzle usually presents a monotonous appearance and lacks aesthetics.

A bathtub massage nozzle is provided which includes a nozzle body, a nozzle core seat and a nozzle surface cover. The nozzle body includes a water inlet end and an opposite water spraying end. The water inlet end is provided with a water inlet and an air inlet, and the air inlet is closer to the water spraying end than the water inlet, and the water spraying end is formed with an accommodating cavity extending to the water inlet. The nozzle core seat is arranged in the accommodating cavity, and is provided with a core seat water inlet hole and a plurality of core seat air inlet holes. The nozzle surface cover is arranged at a distal end of the water spraying end, the nozzle surface cover comprises a nozzle surface cover body and a decorative ring arranged at an end face of the nozzle surface cover body, and a surface of the decorative ring away from the nozzle surface cover body is provided with decorative patterns.

Preferably, the decorative ring is an over-molded decorative ring which is plastic-injected at the end face of the nozzle surface cover body. The decorative ring is ingeniously embedded in the end face of the nozzle surface cover body by injection molding technology, forming a layer of solid and durable over-molded decorative ring. The decorative ring has the characteristics of high flatness and smooth surface, making the nozzle surface cover more exquisite. At the same time, the over-molded decorative ring has excellent wear resistance and aging resistance, keeping its appearance as new for a long time, thus prolonging the service life of the product. Users can not only enjoy the visual aesthetics, but also feel the tactile comfort when using the nozzle. Users will not feel any discomfort when touching with their fingers, providing a more delicate using experience. It should be noted that the physical properties of the nozzle surface cover body are similar to those of the over-molded decorative ring.

Preferably, the decorative ring is detachable. The nozzle surface cover body is provided with an installation slot, and the decorative ring is provided with an installation clasp adapted to the installation slot. The design of the detachable decorative ring allows users to easily remove the decorative ring for cleaning or replacement. This not only maintains the lasting beauty of the product appearance, but also ensures the hygienic condition of the massage nozzle and improves the maintainability of the product. At the same time, users can choose different styles and colors of decorative rings according to their personal preferences and decorative needs. This personalized choice provides more decorative freedom, making the user's bathtub massage nozzle a piece of customized artwork.

Preferably, the decorative pattern is a bi-color decorative pattern. The design of the bi-color decorative pattern makes the nozzle surface cover present a more colorful and layered appearance. This visual richness enhances the attractiveness of the product, making the product more outstanding in the bathtub area, and bringing pleasant visual enjoyment to users.

Preferably, the nozzle core seat is provided with a catch slot, and a side of the nozzle surface cover is provided with a catch engaged in the catch slot.

Preferably, an outer side of the nozzle core seat is provided with an external thread, and an inner side of the nozzle body is provided with an internal thread adapted to the external thread. The nozzle core seat is assembled in the accommodating cavity of the nozzle body through the external thread engaged with the internal thread inside the nozzle body 1.

Preferably, one end of the nozzle core seat away from the core seat water inlet hole is provided with a nozzle core, and the nozzle surface cover is provided with a water outlet corresponding to the nozzle core.

Preferably, the nozzle core can be a spherical nozzle core, a straight nozzle core, a rotary nozzle core or a multi-port nozzle core. In use, different types of nozzle core seats (that is, different nozzle cores) can be chosen according to the user own preferences and needs, such as spherical, straight, rotary or multi-port nozzle cores, so as to obtain personalized and diversified massage effects.

Preferably, the bathtub massage nozzle further includes a fastener with an internal thread, and an installation thread is arranged on an outside of the nozzle body. The fastener cooperates with the nozzle surface cover to clamp the nozzle body for installation and fixation.

Compared with the prior art, the present invention has the following beneficial effects: the present invention provides a bathtub massage nozzle, which includes a nozzle body, a nozzle core seat and a nozzle surface cover. The nozzle surface cover includes a nozzle surface cover body and a decorative ring arranged at an end face of the nozzle surface cover body, and a surface of the decorative ring away from the nozzle surface cover body is provided with decorative patterns. The design of the decorative ring makes the nozzle surface cover more exquisite, and the design of the decorative pattern gives the overall appearance more sense of layering and three-dimensionality, which makes the nozzle not only a functional product, but also more aesthetic, bringing users a pleasant visual experience and satisfying the modern consumers' demands for aesthetics and personalization. It should also be understood that the arrangement of the decorative ring 32 also makes the nozzle have improved wear resistance and aging resistance, which prolongs the service life of the product. Therefore, the bathtub massage nozzle meets the users' demand for better aesthetic feel and comfort, and is a massage nozzle integrating aesthetics, practicality and durability.

### BRIEF DESCRIPTION OF DRAWINGS

FIG. 1 is a perspective view of a bathtub massage nozzle according to one embodiment of the present invention.

FIG. 2 is a perspective view of a bathtub nozzle core seat of the bathtub massage nozzle of FIG. 1.

FIG. 3 is a cross-sectional view of the bathtub nozzle core seat of FIG. 2.

FIG. 4 is a front view of the bathtub nozzle core seat of FIG. 2.

In the Figures:
1—Nozzle body, 2—Nozzle core seat, 3—Nozzle surface cover, 4—Fastener, 5—Installation thread, 11—Water inlet, 12—Air inlet, 21—Core seat water inlet hole, 22—Core seat air inlet hole, 23—External thread, 24—Nozzle core, 31—Nozzle surface cover body, 32—Decorative ring, 33, Decorative pattern.

### DESCRIPTION OF EMBODIMENTS

In order to make objectives, technical solutions and advantages of the embodiments of the present invention clearer, the technical solutions of the embodiments of the present invention will be described clearly and completely below with reference to the accompanying drawings in the embodiments of the present invention.

### Embodiment 1

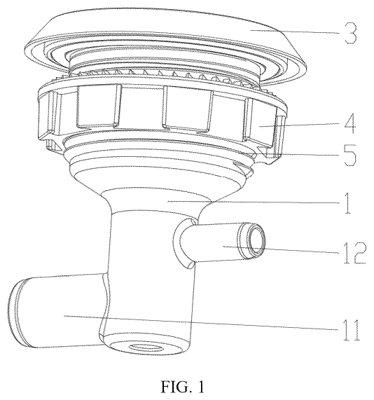

Referring to FIGS. 1 to 4, this embodiment provides a bathtub massage nozzle, which includes a nozzle body 1, a nozzle core seat 2 and a nozzle surface cover 3. The nozzle body 1 includes a water inlet end and an opposite water spraying end, the water inlet end is provided with a water inlet 11 and an air inlet 12, and the air inlet 12 is closer to the water spraying end than the water inlet end, and the water spraying end is formed with an accommodating cavity extending to the water inlet end. The nozzle core seat 2 is arranged in the accommodating cavity, and the nozzle core seat 2 is provided with a core seat water inlet hole 21 and a plurality of core seat air inlet holes 22. The nozzle surface cover 3 is arranged at a distal end of the water spraying end; the nozzle surface cover 3 includes a nozzle surface cover body 31 and a decorative ring 32 arranged at an end face of the nozzle surface cover body 31. A surface of the decorative ring 32 away from the nozzle surface cover body 31 is provided with decorative patterns 33.

Preferably, the decorative ring 32 is an over-molded decorative ring 32 that is injection-molded on the end face of the nozzle surface cover body 31. The decorative ring 32 is ingeniously embedded in the end face of the nozzle surface cover body 31 by injection molding technology, forming a layer of solid and durable over-molded decorative ring 32. The decorative ring 32 has the characteristics of high flatness and smooth surface, making the nozzle surface cover 3 more exquisite. At the same time, the over-molded decorative ring 32 has excellent wear resistance and aging resistance, keeping its appearance as new for a long time, thus prolonging the service life of the product. Users can not only enjoy the visual aesthetics, but also feel the tactile comfort when using the nozzle. Users will not feel any discomfort when touching with their fingers, providing a more delicate using experience. It should be noted that the physical properties of the nozzle surface cover body 31 are similar to those of the over-molded decorative ring 32.

Preferably, the decorative pattern 33 is a bi-color decorative pattern 33. The design of the bi-color decorative pattern 33 makes the nozzle surface cover 3 present a more colorful and layered appearance. This visual richness enhances the attractiveness of the product, making the product more outstanding in the bathtub area, and bringing pleasant visual enjoyment to users.

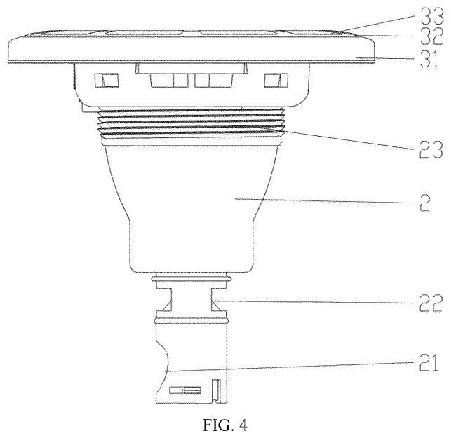

Referring to FIG. 4, it is preferred that the nozzle core seat 2 is provided with a catch slot, and a side of the nozzle surface cover 3 is provided with a catch matched with the catch slot. During installation, the connection between the nozzle surface cover 3 and the nozzle core seat 2 is realized by engaging the catch on the nozzle surface cover 3 into the catch slot at the nozzle core seat 2, which is simple and reliable.

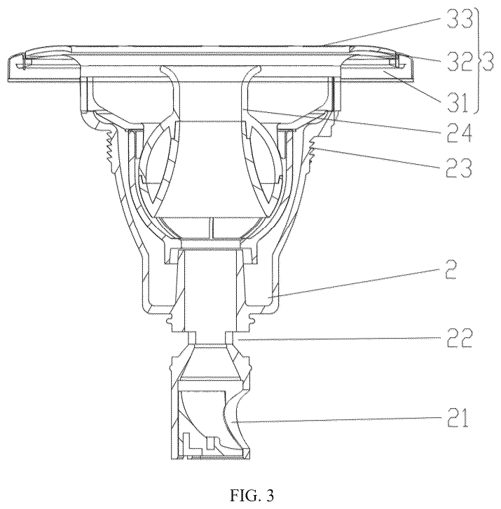

Referring to FIG. 3 and FIG. 4, it is preferred that an outer side of the nozzle core seat 2 is provided with an external thread 23, and an inner side of the nozzle body 1 is provided with an internal thread adapted to the external thread 23. The nozzle core seat 2 is assembled in the accommodating cavity of the nozzle body 1 through the external thread 23 engaged with the internal thread inside the nozzle body 1.

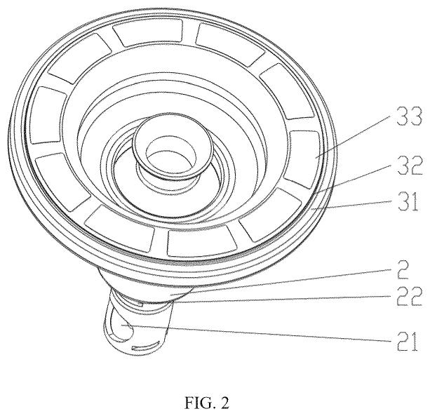

Referring to FIG. 2, it is preferred that the nozzle core seat 2 is provided with a nozzle core 24 at one end away from the water inlet hole 21 of the nozzle core seat, and the nozzle surface cover 3 is provided with a water outlet corresponding to the nozzle core 24. Further, the nozzle core 24 can be a spherical nozzle core 24, a straight nozzle core 24, a rotary nozzle core 24 or a multi-port nozzle core 24. In use, different types of nozzle core seats 2 (that is, different nozzle cores 24) can be chosen according to the user own preferences and needs, such as spherical, straight, rotary or multi-port nozzle cores 24, so as to obtain personalized and diversified massage effects.

Referring to FIG. 1, it is preferred that that the bathtub massage nozzle further includes a fastener 4 provided with an internal thread, and the outer side of the nozzle body 1 is provided with an installation thread 5 corresponding to the internal thread of the fastener 4, and the fastener 4 cooperates with the nozzle surface cover 3 to clamp the nozzle body 1 for installation and fixation.

It should be noted that, in use of the bathtub massage nozzle, the nozzle surface cover 3 is rotated to drive the nozzle core seat 2 to rotate, so that the core seat water inlet hole 21 and the core seat air inlet hole 22 on the nozzle core seat 2 correspond to the water inlet 11 and the air inlet 12 arranged on the nozzle body, respectively. At this time, the nozzle starts to work. When the user wants to stop using the bathtub massage nozzle, the user can simply rotate the nozzle surface cover 3 to make the core seat water inlet hole 21 on the nozzle core seat 2 stagger from the water inlet 11 arranged on the nozzle body. It should also be noted that a sealing rubber ring is arranged between the core seat inlet hole 21 and the core seat inlet hole 22 on the nozzle core seat 2, so as to prevent water from flowing to the air inlet 12.

As described above, the present invention provides a bathtub massage nozzle, which includes a nozzle body 1, a nozzle core seat 2 and a nozzle surface cover 3 The nozzle surface cover 3 includes a nozzle surface cover body 31 and a decorative ring 32 arranged at an end face of the nozzle surface cover body 31, and a surface of the decorative ring 32 away from the nozzle surface cover body 31 is provided with decorative patterns 33. The design of the decorative ring 32 makes the nozzle surface cover 3 more exquisite, and the design of the decorative pattern 33 gives the overall appearance more sense of layering and three-dimensionality, which makes the nozzle not only a functional product, but also more aesthetic, bringing users a pleasant visual experience and satisfying the modern consumers' demands for aesthetics and personalization. It should also be understood that the arrangement of the decorative ring 32 also makes the nozzle have improved wear resistance and aging resistance, which prolongs the service life of the product. Therefore, the bathtub massage nozzle meets the users' demand for better aesthetic feel and comfort, and is a massage nozzle integrating aesthetics, practicality and durability.

### Embodiment 2

Embodiment 2 is substantially the same as Embodiment 1, and the difference is that the decorative ring 32 is detachable, the nozzle surface cover body 31 is provided with an installation slot, and the decorative ring 32 is provided with an installation clasp adapted to the installation slot. The design of the detachable decorative ring 32 allows users to easily remove the decorative ring 32 for cleaning or replacement. This not only maintains the lasting beauty of the product appearance, but also ensures the hygienic condition of the massage nozzle and improves the maintainability of the product. At the same time, users can choose different styles and colors of decorative rings 32 according to their personal preferences and decorative needs. This personalized choice provides more decorative freedom, making the user's bathtub massage nozzle a piece of customized artwork.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

What is claimed is:

1. A bathtub massage nozzle, comprising a nozzle body, a nozzle core seat and a nozzle surface cover, wherein the nozzle body comprises a water inlet end and an opposite water spraying end, the water inlet end is provided with a water inlet and an air inlet, and the air inlet is closer to the water spraying end than the water inlet, and the water spraying end is formed with an accommodating cavity extending to the water inlet; the nozzle core seat is arranged in the accommodating cavity, the nozzle core seat is provided with a core seat water inlet hole and a plurality of core seat air inlet holes, the nozzle surface cover is arranged at a distal end of the water spraying end, the nozzle surface cover comprises a nozzle surface cover body and a decorative ring arranged at an end face of the nozzle surface cover body, and a surface of the decorative ring away from the nozzle surface cover body is provided with decorative patterns.

2. The bathtub massage nozzle according to claim 1, wherein the decorative ring is an over-molded decorative ring which is plastic-injected at the end face of the nozzle surface cover body.

3. The bathtub massage nozzle according to claim 1, wherein the decorative ring is detachable, the nozzle surface cover body is provided with an installation slot, and the decorative ring is provided with an installation clasp adapted to the installation slot.

4. The bathtub massage nozzle according to claim 1, wherein the decorative patterns are bi-color decorative patterns.

5. The bathtub massage nozzle according to claim 1, wherein the nozzle core seat is provided with a catch slot, and a side of the nozzle surface cover is provided with a catch engaged in the catch slot.

6. The bathtub massage nozzle according to claim 1, wherein an outer side of the nozzle core seat is provided with an external thread, and an inner side of the nozzle body is provided with an internal thread engaged with the external thread.

7. The bathtub massage nozzle according to claim 1, wherein one end of the nozzle core seat away from the core seat water inlet hole is provided with a nozzle core, and the nozzle surface cover is provided with a water outlet corresponding to the nozzle core.

8. The bathtub massage nozzle according to claim 1, wherein the nozzle core is one of a spherical nozzle core, a straight nozzle core, a rotary nozzle core and a multi-portion nozzle core.

9. The bathtub massage nozzle according to claim 1, further comprising a fastener with an internal thread, and an installation thread is arranged on an outside of the nozzle body, and the fastener cooperates with the nozzle surface cover to clamp the nozzle body for installation and fixation.
